(19) United States
(12) Patent Application Publication
(10) Pub. No.: US 2006/0197762 A1
(43) Pub. Date: Sep. 7, 2006

(54) Scalable visualizer for heterogeneous data

(75) Inventors: Gregory R. Smith, Bellevue, WA (US); Brian R. Meyers, Issaquah, WA (US); Daniel C. Robbins, Seattle, WA (US); George G. Robertson, Seattle, WA (US); Mary P. Czerwinski, Woodinville, WA (US); Desney S. Tan, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/337,382

(22) Filed: Jan. 23, 2006

Related U.S. Application Data
(60) Provisional application No. 60/658,327, filed on Mar. 2, 2005.

(51) Int. Cl. G06T 11/20

(52) U.S. Cl. 345/440

(57) ABSTRACT

A visualization method for processing heterogeneous data sets. A set of display nodes is generated on a user display that corresponds to groupings of data elements from a set of data. As various display nodes are selected, specific searching criteria corresponding to a selected display node is applied to the set of data. The data nodes on the user display are dynamically updated to reflect the processing of the additional criteria.

### CROSS-REFERENCE TO RELATED APPLICATION

This application claims the benefit of U.S. Provisional Application No. 60/658,327, entitled SCALABLE VISUALIZER FOR HETEROGENEOUS DATA AND METADATA, and filed on Mar. 2, 2005. U.S. Provisional Application No. 60/658,327 is incorporated by reference herein.

### BACKGROUND

Generally described computer systems and communication networks can be used to provide access to a wide variety of data. In a typical scenario, a computer user may wish to search or find data items matching search criteria. Current information searching or information browsing approaches, however, are typically customized to specific types of data or sources of data. For example, an operating system may provide a “shell view” to allow a user to search for data files stored on a computer or on a computer network. Likewise, a Web page, such as a portal, may provide a categorized view of topic headings to guide network computer users to different Web pages. Still further, a commercial Web page may display various product groupings (e.g., price, occasion, type) to increase sales.

Current approaches to information searching or information browsing are limited to applicability to specific types of information sources, such as text documents, digital photos, or Web pages. Thus, many current information searching or information browsing approaches would not be efficient for heterogeneous types of data. Additionally, current information searching or information browsing approaches typically do not scale well and can become deficient as the number of data elements that can be searched increases. Still further, current information searching or information browsing approaches can become deficient in providing computer users with visual context of the current search criteria.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A visualization method for processing heterogeneous data sets is provided. A set of display nodes is generated on a user display that corresponds to groupings of data elements from a set of data. As various display nodes are selected, specific searching criteria corresponding to a selected display node is applied to the set of data. The data nodes on the user display are dynamically updated to reflect the processing of additional searching criteria.

In accordance with an aspect of the present invention, a method for managing the display of data in a computer having a display is provided. In accordance with the method, a computing device displays a set of display nodes on a display. Each display node in the set of display nodes corresponds to a grouping definition of a set of data. The computing device obtains a selection of a display node by a user manipulation. The computing device then filters the set of data based on a grouping definition corresponding to the selected display node. The computing device then updates the set of display nodes on the display corresponding to the filtered set of data. The computing device can dynamically create an expansion region corresponding to a selected display node that displays additional display nodes for further selection of additional filtering criteria. The computing device can also dynamically adjust other display nodes to reflect the application of filtering criteria.

In accordance with another aspect of the present invention, a method for managing the display of data in a computer having a display is provided. In accordance with the method, a computing device displays a set of display nodes on a computer system display. Each display node in the set of display nodes corresponds to filtering criteria for a set of data. The computing device then obtains a selection of a display node and filters the set of data based on the filtering criteria associated with the selected display node. The computing device then updates the set of display nodes on the computer system display corresponding to the filtered set of data.

In accordance with an aspect of the present invention, a method for managing the display of data in a computer having a display is provided. In accordance with the method, a computing device obtains a set of data and displays a set of display nodes on a computer system display. Each display node in the set of display nodes corresponds to filtering criteria for the set of data. The computing device obtains a selection of a display node and filters the set of data based on the filtering criteria associated with the selected display node. The computing device then generates at least one additional display node corresponding to the filtered set of data on the computer system display. The additional display node can be generated in an expansion region of the computer system display.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram illustrative of a data visualization routine implemented by a computing device in accordance with an aspect of the present invention;

FIG. 2 is a flow diagram illustrative of a display node display sub-routine implemented by a computing device in accordance with an aspect of the present invention;

FIG. 3 is a block diagram illustrative of a screen display including a number of facet nodes corresponding to a group of data items in accordance with an aspect of the present invention;

FIG. 4 is a block diagram of the screen display of FIG. 3 illustrating the selection of filtering criteria corresponding to a displayed facet node and the creation of an expansion region on the screen display in accordance of the present invention;

FIG. 5 is a block diagram of the screen display of FIG. 4 illustrating the selection of additional filtering criteria corresponding to a displayed facet node in the expansion region and the adjustment of additional displayed facet nodes; and

FIG. 6 is a block diagram of the screen display of FIG. 5 illustrating the section of addition filtering criteria to a displayed facet node and the creation of a second expansion region on the screen display in accordance with an aspect of the present invention.

### DETAILED DESCRIPTION

Generally described, the present invention relates to a visualization technique and methodology for searching or browsing a set of data. More specifically, the present invention relates to a visualization technique for generating and dynamically updating a set of display nodes corresponding to groupings of data elements from a set of data. Each display node can correspond to grouping of data elements according to one or more grouping definitions. The initial display of data nodes for a set of data can encompass all or a majority of data elements in the set of data. Additionally, a single data element can correspond to more than one display node. As various display nodes are selected by a user, the set of data is filtered with criteria associated with the selected display node. The display is updated to expand the selected display node to include additional display nodes corresponding to additional data groupings. Additionally, the display of non-selected display nodes is updated to correspond to the filtered data set. Although the present invention will be described with regard to illustrative user interfaces, grouping criteria, data element types and/or data sources, one skilled in the relevant art will appreciate that the disclosed embodiments are illustrative in nature and should not be construed as limiting.

In accordance with an aspect of the present invention, the present invention may be utilized in conjunction with a set of data having a number of data elements. For example, data elements can correspond to electronic documents on a file system, Web sites, objects that represent physical items (e.g., books, people, etc.), and the like. Each data element can have any number of attributes that describe aspects of the data element or other information related to the data element. For example, a Web site data element can be described in terms of its domain name, time it was accessed by a computer user, titles, contents, sponsors, etc. The attributes may be specific to a particular type of data element type (e.g., a domain name for a Web page or a camera model for digital image files) or could applicable to a variety of data element types (e.g., time last viewed).

In an illustrative embodiment, the set of data can include one or more common data element types that share attributes. Additionally, at least some portion of the data elements may be heterogeneous data element types that may or may not have overlapping attributes. Ones skilled in the relevant art will appreciate that the data store may correspond to a centralized data store. Alternatively, the data store may correspond to a distributed data store corresponding to any number of computing devices and communication networks. In an illustrative embodiment, aspects of the invention may be implemented in a variety of computing devices, including, but not limited to, personal computers, hand-held computers, mobile computers, mobile telephones, server computers, terminal computers and the like.

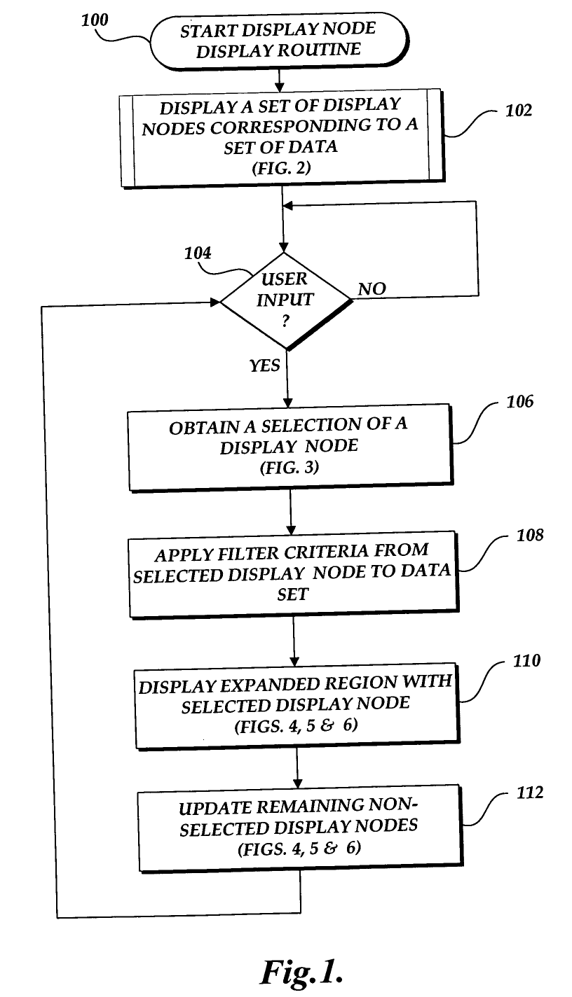

Turning now to FIG. 1, a flow diagram illustrative a display node routine 100 implemented by a computing device in accordance with an aspect of the present invention. At block 102, the computing device generates a set of display nodes from a set of data. The generation of a set of display nodes from a set of data will be described below in greater detail with regard to sub-routine 200. At decision block 104, a test is conducted to determine whether user input is received selecting one or more display nodes. In an illustrative embodiment, the user can utilize a variety of input devices, including keyboard commands, hardware buttons, touch screens, pens, and/or a computer mouse, to select a display node on a user interface. At block 106, the computing device obtains a selection of a display node.

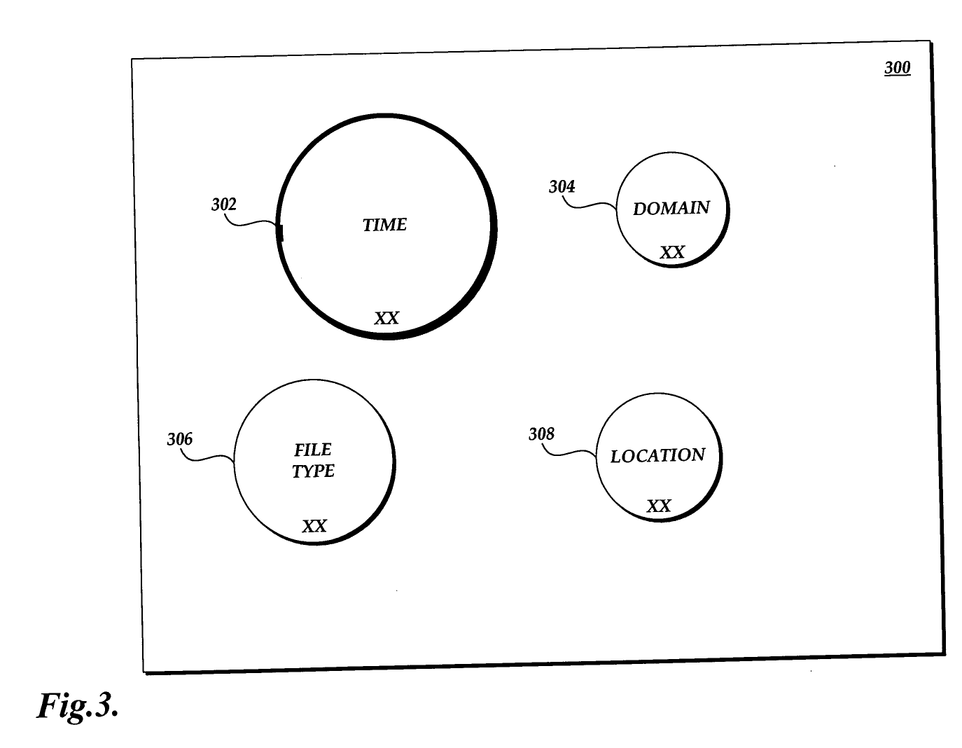

FIG. 3 is a block diagram illustrative of a screen display 300 generated by an illustrative computing device in accordance with an aspect of the present invention. Although the screen display 300 is illustrated as a single screen, one skilled in the relevant art will appreciate that the screen display may encompass any number of shapes and number of computing displays. The screen display 300 includes a display of four display nodes 302, 304, 306, 308, which correspond to a topmost grouping level of data elements. In an illustrative embodiment, the grouping level can correspond to a combination of one or more attributes related to or otherwise associated with the data element. For example, one or more attributes may be associated with a data element as metadata. Each display node 302, 304, 306, 308 can include a textual or graphical identification of the grouping definition associated with the display node and the number of data elements associated with the display node. In an illustrative embodiment, the display nodes may be sized in accordance with the number of data elements associated with the display nodes. For illustrative purposes, display node 302, corresponding to a “time” grouping definition has been selected by a user.

Returning to FIG. 1, at block 108, the computing device applies the filter criteria from the selected display node to the set of data. The computing device can utilize any one of a number of filtering algorithms to process the set of data in accordance with the selected node In an illustrative embodiment, the computing device can filter the data set as the display node selection is made by the user. Alternatively, the computing device can pre-process one or more user selections to improve user interaction.

At block 110, the computing device can display an expanded region on the screen display that corresponds to the selected display node. In an illustrative embodiment of the present invention, the display output is adjusted such that the selected display node is expanded in a dedicated region on the screen display. Alternatively, the selected display node could be expanded to a different area of the display or to a different display entirely. In an illustrative embodiment, the degree of the expansion of the selected display node could be determined by an automated calculation. For example, the relative usefulness of the expansion can be determined by considering criteria such as the number of data elements in the selected display node or the number of additional grouping definitions available within the selected display node. In a further embodiment, additional adaptive criteria, such as frequency of selection and/or recency of selection of the display node may also be utilized to determine the extent of the expansion. With continued reference to block 110, one or more additional display nodes corresponding to additional grouping definitions or actual data elements in the data set can be displayed in the expanded region. The additional display nodes allow the user to select more specific search criteria related to the selected display node.

At block 112, the computing device updates the remaining, non-selected display nodes. In an illustrative embodiment, the computing device can modify the appearance of the non-selected display nodes. For example, if all the data elements corresponding to a non-selected display node are filtered out, the computing device can cause the display node to disappear, become transparent or otherwise indicate that it no longer contains any data elements. In an another embodiment, the non-selected display nodes can be updated to display an updated number of data elements included in the display node and/or updated to reflect a new size reflective of the updated number of data elements included in the display node.

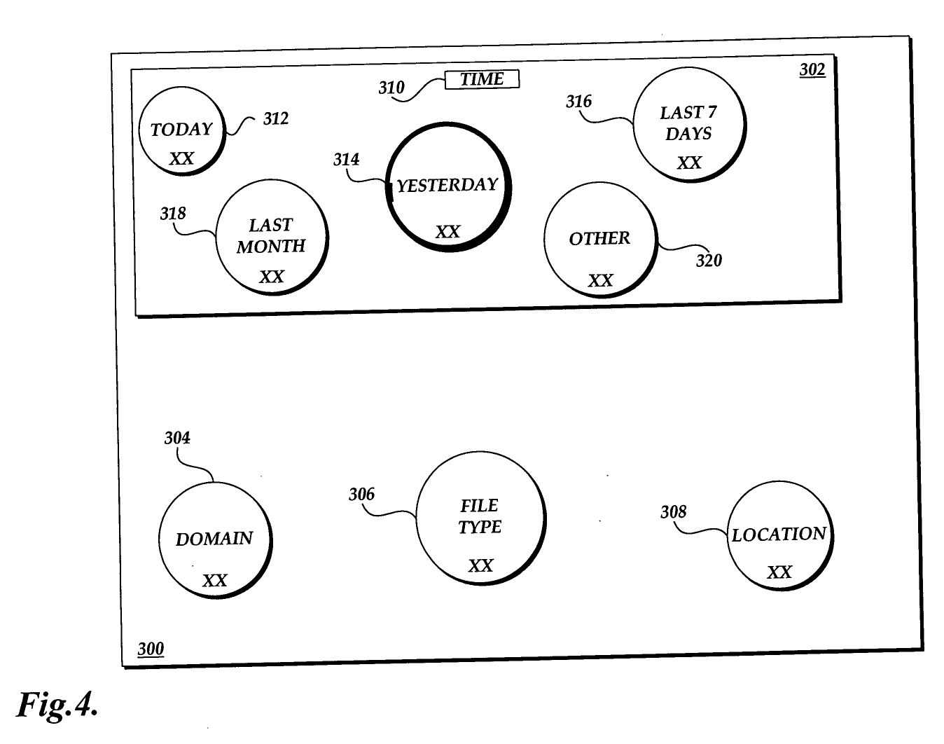

FIG. 4 is a block diagram of the screen display 300 of FIG. 3 illustrating the selection of filtering criteria corresponding to a displayed facet node and the creation of an expansion region on the screen display in accordance of the present invention. As described above with reference to FIG. 3, for illustrative purposes, display node 302 has been selected. Accordingly, the computing device updates the screen display to generate a region 302 where the display node is expanded. The region 302 includes an identification component 310 that indicates the grouping definition corresponding to the expanded region, e.g., “time”. In an illustrative embodiment, the identification component 310 can be a selectable display object that allows the user to undo the selection or other function.

The expanded region 302 also includes a set of additional display nodes 312, 314, 316, 318, 320 that correspond to more detailed grouping definitions associated with selected display node. As illustrated in FIG. 4, the additional display nodes for the selected time display node 302 corresponds to various time related grouping definitions such as “today”, “yesterday”, “last 7 days”, “last month” and “other”. As will be explained in greater detail below, the “other” data node 320 correspond to a data node that encompasses other potential data nodes that cannot otherwise be displayed due to display constraints and/or data node minimum size limitations. As explained above, a specific data element may correspond to more than one of the additional display nodes. With continued reference to FIG. 4, display nodes 304, 306 and 308 can be updated to indicate a new number of data elements within the grouping definitions based on the filtered data set. Additionally, the size, color or other formatting of the display nodes 304, 306, 308 can also be updated. In the illustrated example, each of the grouping definitions represented by display nodes 304, 306 and 308 would now only reference data elements that had a “time” attribute since the time display node 302 has been selected as the overall filtering criterion.

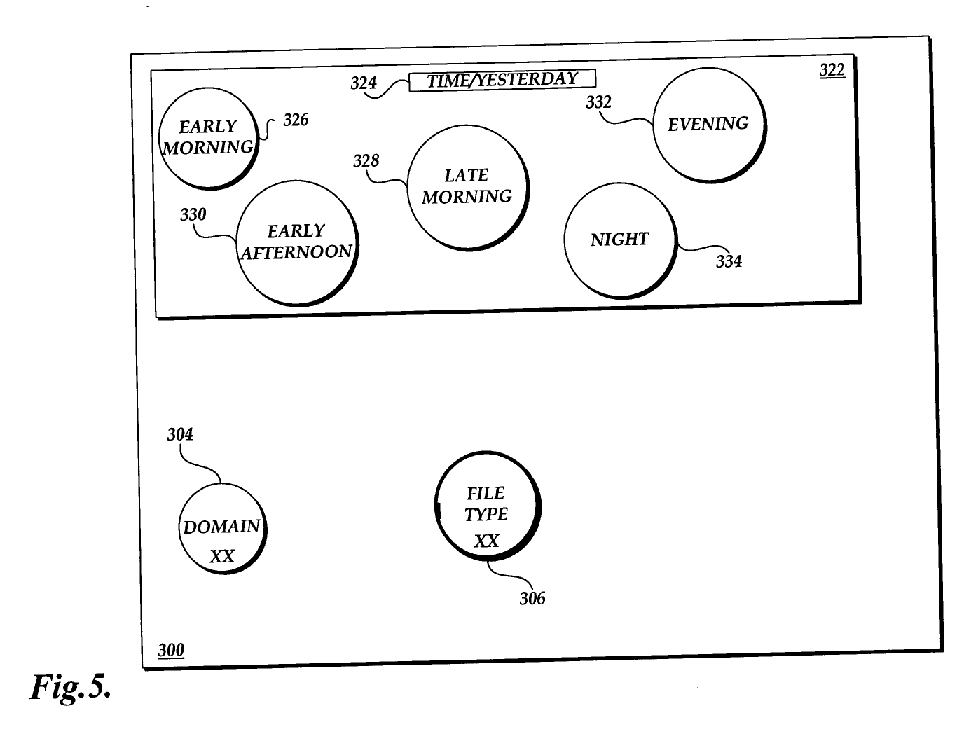

Referring now to FIG. 5, assuming that a user has made an additional selection of display node 314 (FIG. 4) corresponding to a “yesterday” grouping definition, the computing device updates the screen display 300 to generate a new region 322 corresponding to the additional selected display node grouping definition. In this illustrative embodiment, the computing device does not need to generate a new region because the user's selection corresponded to a further refinement of the previously selected display node 302 (FIG. 3). The updated region 322 includes an identification component 324 that indicates the two grouping definitions corresponding to the expanded region, e.g., “time” and “yesterday”. The expanded region 322 also includes a set of additional display nodes 326, 328, 330, 332, 334 that correspond to more detailed grouping definitions associated with the previously selected display nodes. As illustrated in FIG. 5, the additional display nodes for the selected time display node 302, “time”, and display node 314, “yesterday”, correspond to various time related grouping definitions for the time period “yesterday” such as “early morning”, “late morning”, “early afternoon”, “evening” and “night”. In an illustrative embodiment, although additional group definitions may exist, such as “late afternoon”, the computing device can omit display nodes that do not contain any data elements. With continued reference to FIG. 5, display nodes 304 and 306 can be updated to indicate a new number of data elements within the grouping definitions based on the filtered data set. Additionally, the size, color or other formatting of the display nodes 304, 306, 308 can also be updated. In this illustrative example, display node 308 has been removed from the screen display 300 to indicate that the filtered set of data elements no longer contains elements with the “location” attribute.

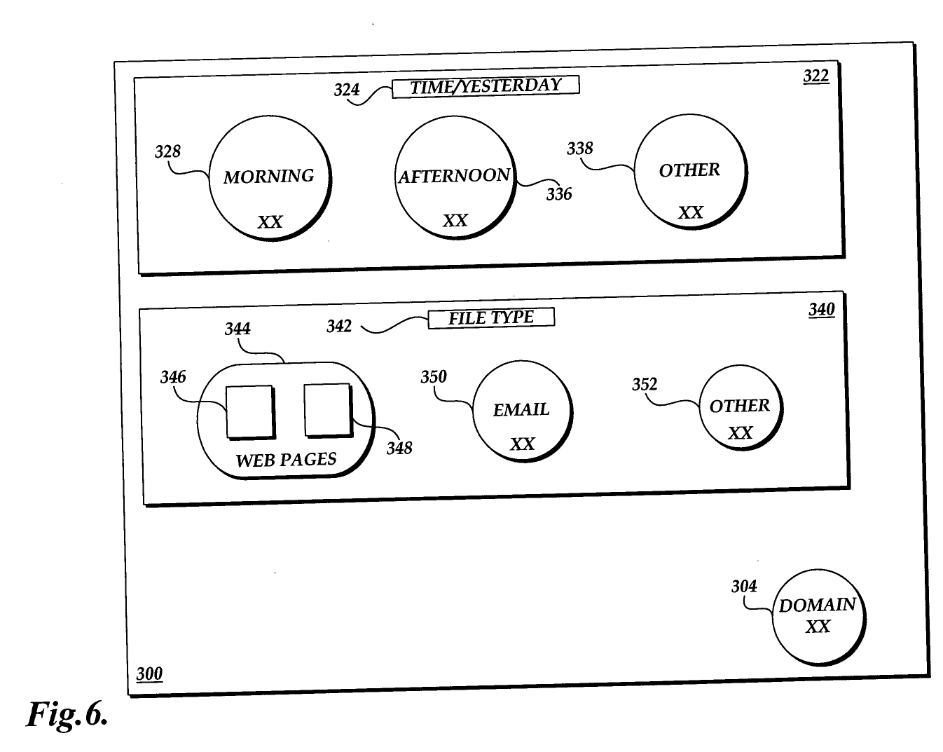

Referring now to FIG. 6, assuming that a user has made an additional selection of display node 306 (FIG. 5) corresponding to a “file type” grouping definition, the computing device updates the screen display 300 to generate a new region 340 corresponding to the additional selected display node grouping definition. In this illustrative embodiment, the computing device generates a new region 340 that is an expansion of the selected display node. As illustrated in FIG. 6, region 322 and region 340 are equally divided in the screen display 300. As previously described, in an illustrative embodiment, the location and degree of expansion for regions 322 and 340 can be based on several factors. Additionally, the expansion of each region may be based, in part, on the expansion of each region 322, 340. The region 340 includes an identification component 342 that indicates the additional grouping definition corresponding to the expanded region, e.g., “file type”. The expanded region 322 also includes a set of additional display nodes 344, 350 and 352 that correspond to more detailed grouping definitions associated with the previously selected display nodes.

As illustrated in FIG. 6, the additional display nodes for the selected display node 306, “file type”, correspond to various file types such as “Web pages”, “Email” and “other”. Additionally, display node 344 includes two additional display objects 346 and 348 that correspond to representations of actual individual data elements in the set of data. In an illustrative embodiment, the display objects 346 and 348 can include descriptive text or images that identify the data element. With continued reference to FIG. 6, display node 304 and expanded region 322 can be updated to indicate a new number of data elements within the grouping definitions based on the filtered data set. Additionally, the size, color or other formatting of the display nodes 304 can also be updated. As illustrated, some of the data elements in region 322 have disappeared or been otherwise rearranged to leave only display nodes 328, 336 and 338.

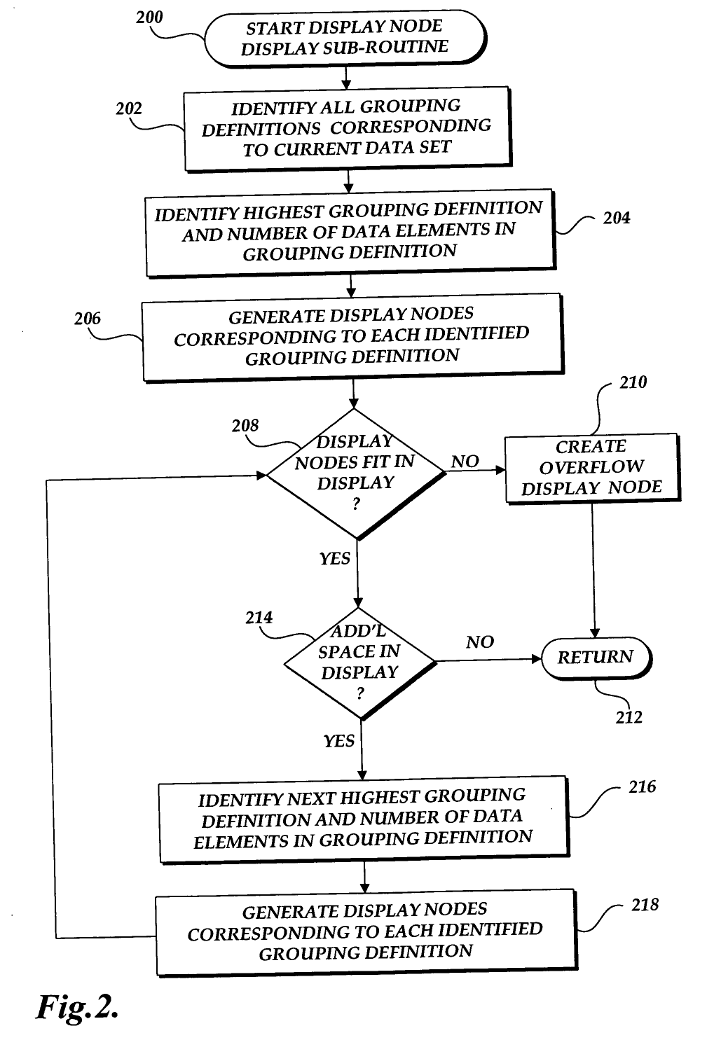

Turning now to FIG. 2, an illustrative sub-routine 200 for generating display nodes from a set of data and corresponding to block 102 (FIG. 1) will be described. At block 202, the computing device identifies all grouping definitions corresponding to a current set of data. In an illustrative embodiment, the grouping definitions may be obtained from various identifiers associated with the set of data, such as column headings for a database or hierarchical definitions from structured data, such as XML. Additionally, the grouping definitions may be defined manually by a computer user, system administrator, or software provider. Additionally, the grouping definitions may be defined by various automated textual or graphical clustering techniques. Still further, the grouping definitions may be based on collaborative filtering techniques incorporating the operations of groups of users. In an illustrative embodiment, the grouping definitions may be hierarchically defined in single analysis that results in a topmost level (e.g., coarsest granularity) to a bottommost level (e.g., finest granularity). Alternatively, the grouping definitions may be dynamically applied such that grouping definitions are determined dynamically as additional grouping definitions are required.

At block 204, the computing device identifies the highest appropriate grouping definitions and the number of elements associated with each of these groups. In an illustrative embodiment, the computing device can utilize additional factors in identifying the highest appropriate grouping definitions. The computing device may consider the number of selections a user would have in selecting the grouping definition. For example, for a location grouping definition, all the data elements in a set of data may correspond to a same country. Accordingly, the highest appropriate grouping definition would likely be on a sub-country region. In an illustrative embodiment, the computing device does not need to maintain the full list of all the grouping definitions at a current level or a list of which data elements are included in the highest grouping definition.

At block 206, the computing device generates display nodes for each of the highest grouping definitions having at least one data element from the set of data. In an alternative embodiment, the computing device can also generate display nodes for grouping definitions that don't have any data elements from the set of data. These additional display elements could be distinguished on the display. In an illustrative embodiment, the computing device can utilize a variety of organization criteria to determine the order and/or layout of the selected display nodes. For example, for a grouping definition related to “people”, the display nodes can be organized alphabetically. The ordering and/or layout can be determined by various application defaults and/or user preferences. Additionally, the ordering and layout may be dynamically changed.

At decision block 208, a test is conducted to determine whether all the identified display nodes fit in the display. In an illustrative embodiment, the computing device can maintain a minimum threshold size for each display node. If the number of display nodes of minimum size would exceed the available display space, at block 210, the computing device generates an overflow display node that encompasses multiple display nodes. At block 212, the sub-routine 200 returns as no additional display space exists.

Returning to decision block 208, if all the display nodes fit within the display space, at decision block 214, a test is conducted to determine whether the display has any additional space for more display nodes. In an illustrative embodiment, the computing device can generate additional display nodes within the higher grouping definition display nodes if the additional display nodes can be of the minimum threshold size. An example of the display of embedded display nodes is display node 344 (FIG. 6). If no additional space is available, the sub-routine 200 returns at block 212. Alternatively, at block 216, the computing device selects the next highest appropriate grouping definition and the number of data elements associated with this grouping definition for at least a subset of the previously displayed display node. In an illustrative embodiment, the computing device can select which of the grouping definitions will be applied based upon various prioritization criteria such as the number of data elements in the grouping definition, a prioritization of specific grouping definitions, user preferences, and the like. In an illustrative embodiment, if any of the display nodes correspond to individual data elements, they cannot be further divided and a representation of the individual data element can be generated on the display. At block 218, the computing device generates display nodes for each of the next highest grouping definition having at least one data element from the set of data. The sub-routine 200 returns to decision block 208 to continue recursively expanding the set of display nodes until no additional display space is available.

While illustrative embodiments have been illustrated and described, it will be appreciated that various changes can be made therein without departing from the spirit and scope of the invention.

1. In a computer system having a display, a method for managing the display of data comprising:
generating a set of display nodes on a computer system display, wherein each display node in the set of display nodes corresponds to a grouping definition of a set of data;
obtaining a selection of a display node;
filtering the set of data based on a grouping definition corresponding to the selected display node; and
updating the set of display nodes on the display corresponding to the filtered set of data.

2. The method as recited in claim 1, wherein displaying the set of display nodes includes:
identifying all display nodes corresponding to a topmost organizational criteria in the current set of data;
determining whether all display nodes corresponding to the topmost organizational criteria can be generated on the display;
identifying a next highest grouping of organizational criteria for the current set of data;
generating an additional set of display nodes on the computer system display, wherein the additional set of display nodes correspond to the next highest grouping of organizational criteria.

3. The method as recited in claim 1, wherein generating the set of display nodes includes generating a textual identifier for each display node and a number of identifiable elements corresponding to the display nodes on the computer system display.

4. The method as recited in claim 1, wherein updating the set of display nodes on the display includes adjusting a size for all display nodes on the computer system display.

5. The method as recited in claim 1, wherein updating the set of display nodes on the computer system display corresponding to the filtered set of data includes:
generating a region on the computer system display corresponding to the selected display node; and
generating at least one additional display node in the region, wherein the at least one additional display node in the region corresponds to a sub-topic of the selected grouping definition.

6. The method as recited in claim 1, wherein updating the set of display nodes on the computer system display corresponding to the filtered set of data includes removing at least one display node not corresponding to the filtered set of data from the computer system display.

7. The method as recited in claim 1, wherein determining whether all display nodes corresponding to the topmost organizational criteria can be generated on the computer display includes determining whether the set of data can be represented by display nodes of a threshold size on the computer system display.

8. The method as recited in claim 1, wherein updating the set of display nodes on the display corresponding to the filtered set of data includes displaying at least one preview corresponding to an element in the data set.

9. The method as recited in claim 1 further comprising:
obtaining a selection of a second display node;
filtering the set of data based on a grouping definition corresponding to the second selected display node; and
updating the set of display nodes on the display corresponding to the filtered set of data.

10. In a computer system having a display, a method for managing the display of data comprising:
generating a set of display nodes on a computer system display, wherein each display node in the set of display nodes corresponds to filtering criteria for a set of data;
obtaining a selection of a display node;
filtering the set of data based on the filtering criteria associated with the selected display node; and
updating the set of display nodes on the computer system display corresponding to the filtered set of data.

11. The method as recited in claim 10, wherein generating the set of display nodes includes:
identifying all display nodes corresponding to a topmost organizational criteria in the current set of data;
determining whether all display nodes corresponding to the highest organizational criteria can be generated on the computer system display;
identifying a next highest grouping of filtering criteria for the current set of data;
generating an additional set of display nodes corresponding to the next highest grouping of organizational criteria.

12. The method as recited in claim 10, wherein generating the set of display nodes on the computer system display includes generating a textual identifier for each display node and a number of identifiable elements corresponding to the display nodes on the computer system display.

13. The method as recited in claim 10, wherein updating the set of display nodes on the display includes adjusting a size for all display nodes on the display.

14. The method as recited in claim 10, wherein updating the set of display nodes on the display corresponding to the filtered set of data includes:
generating a region on the computer system display corresponding to the selected display node; and
generating at least one additional display node in the region, wherein the at least one additional display node in the region corresponds to a sub-topic of the selected filtering criteria.

15. The method as recited in claim 10, wherein updating the set of display nodes on the display corresponding to the filtered set of data includes removing at least display node not corresponding to the filtered set of data from the computer system display.

16. The method as recited in claim 10 further comprising:
obtaining a selection of a second display node;
filtering the set of data based on filtering criteria corresponding to the second selected display node; and
updating the set of display nodes on the display corresponding to the filtered set of data.

17. In a computer system having a display, a method for managing the display of data comprising:
obtaining a set of data;
generating a set of display nodes on a computer system display, wherein each display node in the set of display nodes corresponds to filtering criteria for the set of data;
obtaining a selection of a display node;
filtering the set of data based on the filtering criteria associated with the selected display node; and
generating at least one additional display node corresponding to the filtered set of data.

18. The method as recited in claim 17, wherein generating the set of display nodes on the computer system display includes generating a textual identifier for each display node and a number of identifiable elements corresponding to the display nodes on the computer system display.

19. The method as recited in claim 17 further comprising updating the set of display nodes on the computer system display corresponding to the filtered set of data.

20. The method as recited in claim 17 further comprising:
generating a region on the computer system display corresponding to the selected display node; and
generating at least one additional display node in the region, wherein the at least one additional display node in the region corresponds to a sub-topic of the selected display node.
